(19) United States
(12) Patent Application Publication
(10) Pub. No.: US 2016/0290948 A1
(43) Pub. Date: Oct. 6, 2016

(54) ELECTROCHEMICAL SYSTEM COMPRISING A COMPARISON ELECTRODE AND CORRESPONDING MANUFACTURE METHOD

(71) Applicant: RENAULT s.a.s, Boulogne-Billancourt (FR)

(72) Inventors: Sylvie GENIES, Saint Egreve (FR); Melanie ALIAS, Poligny (FR); Sylvain LEIRENS, Grenoble (FR)

(73) Assignee: RENAULT s.a.s., Boulogne-Billancourt (FR)

(21) Appl. No.: 15/038,175

(22) PCT Filed: Nov. 19, 2014
(86) PCT No.: PCT/FR2014/052960

§ 371 Date: May 20, 2016

(30) Foreign Application Priority Data
Nov. 21, 2013 (FR) 1361464

(51) Int. Cl. G01N 27/30; G01N 27/403

(52) U.S. Cl. CPC G01N 27/301; G01N 27/403

(57) ABSTRACT

An electrochemical system includes an electrolyte that includes at least one ionic form of a chemical element A chosen from lithium and sodium. The electrolyte is in contact with a comparison electrode, a working electrode and a counterelectrode. The comparison electrode includes a first part in contact with the electrolyte and including a metal M capable of alloying with the chemical element, or a metal alloy of the metal M and of the chemical element A. The comparison electrode also includes a second part including an electrically conducting material, chemically inert with respect to the chemical element A and its ionic form and in direct contact with the first part of the comparison electrode.

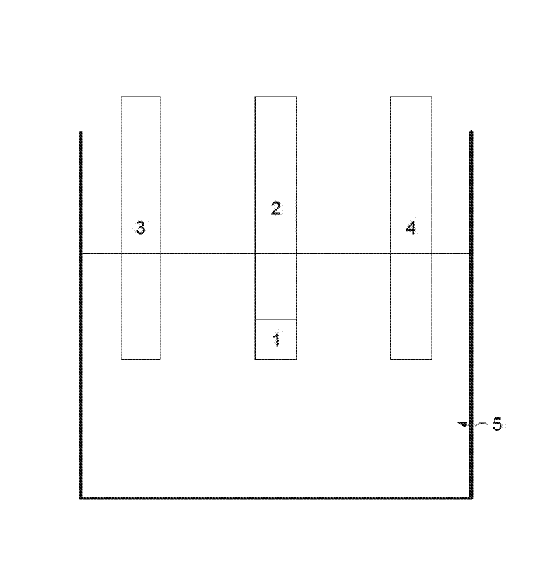

The technical field of the invention is electrochemistry and more particularly the field of electrochemical measuring sensors of the comparison electrodes type.

A comparison electrode is used as third electrode in an electrochemical cell comprising a working electrode (positive electrode in a battery) and a counterelectrode (negative electrode in a battery). It makes it possible to electrically characterize the other two electrodes.

Generally, the comparison electrode (CE) is described as reference electrode (RE) when the concentration of the oxidizing and reducing entities on which the value of the potential depends is unchanging over time. If not, the term of comparison electrode is more generally retained.

Specifically, a comparison electrode (CE) can be employed even if the concentration of the oxidizing and reducing entities on which the value of the potential depends may change over time. However, this change must be very slow during the time of the measurement or of the use and thus be able to be regarded as negligible; it is under this condition that the potential may be regarded as stable.

The incorporation of an RE or of a CE within an electrochemical system is known to make it possible to characterize the operation of the working electrode and of the counterelectrode independently. Its advantage is twofold for the understanding of the phenomena which take place at the electrodes of the electrochemical system and for the development of the applications which result therefrom, such as the storage of energy, the development of sensors and corrosion.

The following documents are known from the state of the art:

The document US 2009/0104510 discloses the use of a CE for the measurement of the states of charging and of aging of lithium-ion batteries. The type of CE provided comprises a material of two-phase type in order to have available a stable voltage plateau whatever the state of lithiation of the electrochemical pair under consideration. The pair put forward in this patent is Li₄Ti₅O₁₂/Li₇Ti₅O₁₂ (acronym LTO). A nonexhaustive list comprises other pairs, in particular lithiated alloys and lithium phosphates. However, electrodes based on coated material, such as an LTO or LFP (lithium ferrophosphate: FePO₄/LiFePO₄) ink, undergo degradation over time, which accelerates with the temperature. This leads to a more or less rapid drift of the potential beyond the plateau value.

The paper “Will advanced lithium-alloy anodes have a chance in lithium-ion batteries” (J. O. Besenhard, J. Yang and M. Winter, J. Power Sources, 68 (1997), 87-90) discloses that lithium alloys are advantageous candidates due to their broad potential plateau.

The comparison of an RE of LTO type and of an electrode of LiₓAl type shows that the alloys offer very good stability over time of the voltage measurement.

Nevertheless, it appears that, when the lithium is reduced over a region delimited by the immersion in the electrolytic solution of the electrochemical cell, it subsequently diffuses over the entire body of the metal constituting the RE. The volume to be lithiated is thus not controlled and the degree of lithiation is difficult to monitor. The slow diffusion of the lithium into the material may bring about a slow drift in the potential of the CE.

There thus exists a problem of stability over time of the reference potential of an electrochemical cell comprising a comparison electrode, in particular an electrode based on lithium alloy.

A subject matter of the invention is an electrochemical system comprising an electrolyte comprising at least one ionic form of a chemical element A chosen from lithium and sodium, in contact with a comparison electrode, a working electrode and a counterelectrode. The comparison electrode comprises a first part in contact with the electrolyte comprising a metal M capable of alloying with said chemical element A, or a metal alloy AM of said metal and said chemical element A, and a second part consisting of an electrically conducting material, chemically inert with respect to the chemical element and its ionic form, and in direct contact with the first part of the comparison electrode.

Material chemically inert with respect to the chemical element A and its ionic form A^{Z+} is understood to mean a material which does not react chemically with the chemical element and its ionic form under the conditions of operation of the electrochemical system (temperature, potential, and the like). The material of the second part is also inert with respect to the electrolyte in general.

The electrolyte can be liquid or solid.

Advantageously, the whole of the surface of the first part can be in contact with the electrolyte. In the case of a liquid electrolyte, the first part can be completely immersed in the liquid electrolyte.

On the other hand, the second part can advantageously comprise a part which is not in contact with the electrolyte, in order to make contacting possible.

The chemical element can be lithium and the metal M can be chosen from aluminum, bismuth, antimony, indium and tin. The metals M are metals capable of alloying with lithium to form an alloy LiₓM with a lithium content x of less than 1.

The chemical element A can be sodium and the metal M can be chosen from tin, alloys of tin and of antimony, lead, germanium and silicon. These metals M are metals capable of alloying with sodium to form an alloy NaₓM with a sodium content equal to x.

The electrically conducting material of the second part can be a metal material, advantageously chosen from nickel and/or platinum.

The electrically conducting material of the second part is a ceramic material chosen from ReO₂, ReO₃, Cr₂O₃, VO and TiO.

Another subject matter of the invention is a process for the manufacture of an electrochemical system comprising an electrolyte containing at least an ionic form of a chemical element, in contact with a comparison electrode, a working electrode and a counterelectrode. The process comprises the following stages:

the assembling is carried out of the comparison electrode comprising a first part in direct contact with the second part, the first part in contact with the electrolyte and comprising a metal M capable of alloying with said chemical element A, or a metal alloy AM of said metal M and of said chemical element A, the second part consisting of an electrically conducting material, chemically inert with respect to the chemical element and its ionic form, and the first part is doped with the ionic form of the chemical element of the electrolyte.

The chemical element can be lithium and the metal can be chosen from aluminum, bismuth, antimony, indium and tin.

The chemical element can be sodium and the metal can be chosen from tin, alloys of tin and of antimony, lead, germanium and silicon.

The electrically conducting material of the second part can be a metal material, advantageously chosen from nickel or platinum.

The electrically conducting material of the second part can be a ceramic material chosen from ReO₂, ReO₃, Cr₂O₃, VO and TiO.

The comparison electrode can be assembled in the electrochemical system and then the first part is doped by applying a current between the working electrode, the counterelectrode and the comparison electrode, all three immersed at least in part in the electrolyte.

The first part can be brought into direct contact with the second part by a metallurgical method, by a chemical method, by a physical method or by an electrochemical method.

Other aims, characteristics and advantages will become apparent on reading the following description, given solely as nonlimiting example and made with reference to the single appended FIGURE, which illustrates an electrochemical system comprising a comparison electrode according to the invention.

The following description refers to the lithium-ion technology. The person skilled in the art can easily extend this teaching to other battery technologies, such as that of sodium-ion batteries, or of other fields of application, such as those of electrochemical sensors.

In order to obtain a functional comparison electrode in a lithium-ion system, several methods of activation, also known as “functionalization”, can be employed in order to precisely define the stoichiometry of the oxidation/reduction pair under consideration. It is thus possible to adjust the potential of the electrode by modifying the content of lithium in the lithiated phase. This stage can be carried out ex situ, before the incorporation of the RE in the system. It can also be carried out in situ by using the working electrode or the counterelectrode as source of lithium for the lithiation. The latter case is described below.

The in situ functionalization of a comparison electrode can be carried out by different electrochemical methods, such as, in particular, chronoamperometry, chronopotentiometry or cyclic voltammetry. The lithiation then normally takes place throughout the volume of the RE immersed in the electrolyte.

However, after this stage, phenomena of slow diffusion of the lithium within the metal result in a homogenization of the concentration of lithium throughout the volume of the RE, including in the nonimmersed part of the electrode, that is to say outside the electrochemically active milieu (negative electrode/electrolyte/positive electrode) proper. The alloy is subsequently detrimentally affected on contact with the air, in particular by interaction with the moisture of the air and/or oxygen.

The consumption of the lithium by side reaction with oxidizing entities (H₂O, O₂, and the like) results in a decrease in the concentration of lithium in the alloy toward low contents (x<0.1 in LiₓAl). According to the content x achieved, the potential of the electrode can drift out of the potential plateau.

In order to avoid such drifts, it is necessary to control the stoichiometry of the metal/lithiated metal pair in order to retain the mechanical structure of the electrode, while having available elements which make it possible to prevent the diffusion of the lithium over the whole of the body of this electrode.

For this, the comparison electrode comprises a first part 1 corresponding to the normal active region of the electrode. The comparison electrode additionally comprises a separate second part 2, placed in direct contact with the first part 1, in order to keep the lithium in the first part 1 and to prevent the diffusion thereof through the part of the electrode which is not in contact with the electrolyte. Thus, the first part 1 corresponds to the region immersed in the electrolyte 5 when the latter is liquid, while the second part 2 comprises a material which is chemically inactive with respect to the lithium, the Li⁺ ion and more particularly with the electrolyte. The assembly is illustrated by the single FIGURE. The electrochemical system illustrated also comprises a working electrode 3 and a counterelectrode 4. The second part 2 must be stable in the electrochemical range of operation of the cell with respect to the electrolyte. The second part 2 can be made of nickel or platinum (or any other metal not forming an alloy with the lithium). Such a structure makes it possible to prevent the migration of the lithium after the lithiation of the first part 1.

It is also possible to employ a ceramic material exhibiting a satisfactory electrical conduction. Such ceramics can be chosen from ReO₂, ReO₃, Cr₂O₃, VO and TiO (Techniques de l'Ingénieur [Techniques of the engineer], F. J. -.M.Haussonne, E 1 820-1 to 11), which exhibit a similar electron conduction band to that of the metals.

The structure of the comparison electrode can be highly variable according to the format of the lithium-ion electrochemical system to be instrumented. The system can comprise a stack or a winding of electrodes. Furthermore, the comparison electrode can be provided in the wire, grid or plate form. It can be positioned on the section of the electrochemical system (wound or stacked) or between strips of electrodes, the RE being itself electrically insulated by a separator film. Finally, it is incorporated in the separator. It should be remembered that a separator makes it possible to physically separate a working electrode from a counterelectrode positioned close to one another.

The first and second parts can be brought into contact by a metallurgical method (soldering), by a chemical method (chemical vapor deposition (CVD)), by a physical method (physical vapor deposition (PVD)) or by an electrochemical method (electrodeposition), the first part 1 being deposited on the second part 2. In comparison with the metallurgical method, the chemical, physical and electrochemical methods make it possible to reduce the contact resistance and thus the electrical resistance between the two parts.

For example, the comparison electrode comprises a first part 1 made of lithium-aluminum alloy LiₓAl. The content x is then chosen to be less than 1 in order to be situated in the plateau of the potential range described in the literature. A greater content would result in a loss in mechanical strength resulting from a significant expansion in volume.

This functionalization in addition has to be carried out in a single lithiation stage. A functionalization in several stages would involve the application of several charging-discharging cycles which can induce a significant expansion in volume.

In the field of lithium-ion batteries, the comparison electrode made of alloy is more stable over time and in temperature than a composite electrode (produced with an ink). It can be made use of as reliable indicator of the state of aging of lithium-ion batteries.

According to one embodiment, the comparison electrode comprises a stack of two superimposed layers. The first layer can be made of ceramic material. This first layer corresponds to the second part, referenced 2 above. A second layer corresponding to the first part, referenced 1 above, is subsequently deposited on this first layer. This second layer is deposited, for example by CVD, in the form of a layer which is smaller in thickness than the first layer. The second layer can be made, for example, of metal capable of alloying with the lithium Li.

1-14. (canceled)

15. An electrochemical system, comprising:
an electrolyte comprising at least one ionic form of a chemical element A chosen from lithium and sodium, in contact with a comparison electrode, a working electrode and a counterelectrode,
wherein the comparison electrode comprises:
a first part in contact with the electrolyte and comprising a metal M capable of alloying with said chemical element, or a metal alloy of said metal M and of said chemical element A, and
a second part consisting of an electrically conducting material, chemically inert with respect to the chemical element A and its ionic form and in direct contact with the first part of the comparison electrode.

16. The system as claimed in claim 15, in which the chemical element A is lithium and the metal M is chosen from aluminum, bismuth, antimony, indium and tin.

17. The system as claimed in claim 16, wherein the first part consists of aluminum or of the alloy LiₓAl with a lithium content of less than 1, the electrolyte comprising lithium ions.

18. The system as claimed in claim 15, in which the chemical element A is sodium and the metal M is chosen from tin, alloys of tin and of antimony, lead, germanium and silicon.

19. The system as claimed in claim 15, in which the electrically conducting material of the second part is a metal materia chosen from nickel and platinum.

20. The system as claimed in claim 15, in which the electrically conducting material of the second part is a ceramic material chosen from ReO₂, ReO₃, Cr₂O₃, VO and TiO.

21. A method of manufacturing of an electrochemical system comprising an electrolyte containing at least an ionic form of a chemical element A, in contact with a comparison electrode, a working electrode, and a counterelectrode, the method comprising:
assembling the comparison electrode, the comparison electrode comprising a first part in direct contact with a second part, the first part in contact with the electrolyte and comprising a metal M capable of alloying with said chemical element, or a metal alloy of said metal M and of said chemical element A, the second part consisting of an electrically conducting material, chemically inert with respect to the chemical element A and its ionic form; and
doping the first part with the ionic form of the chemical element A of the electrolyte.

22. The method as claimed in claim 21, in which the chemical element A is lithium and the metal M is chosen from aluminum, bismuth, antimony, indium and tin.

23. The method as claimed in claim 21, in which the chemical element A is sodium and the metal M is chosen from tin, alloys of tin and of antimony, lead, germanium and silicon.

24. The method as claimed in claim 21, in which the electrically conducting material of the second part is a metal material chosen from nickel or platinum.

25. The method as claimed in claim 21, in which the electrically conducting material of the second part is a ceramic material chosen from ReO₂, ReO₃, Cr₂O₃, VO and TiO.

26. The method as claimed in claim 21, in which the comparison electrode is assembled in the electrochemical system and then the first part is doped by applying a current between the working electrode, the counterelectrode, and the comparison electrode, and the working electrode, the counterelectrode, and the comparison electrode are immersed in the electrolyte.

27. The method as claimed in claim 21, in which the first part is brought into direct contact with the second part by a metallurgical method, by a chemical method, by a physical method, or by an electrochemical method.
